(19) United States
(12) Patent Application Publication
(10) Pub. No.: US 2025/0026005 A1
(43) Pub. Date: Jan. 23, 2025

(54) Connector for Modular Components

(71) Applicant: XTEND AI Inc., Middleburg, FL (US)

(72) Inventors: Harry Fox, Jerusalem (IL); David Fabian Rubli, Revava (IL); Boris Zlotnikov, Tel Aviv (IL); Andrew C. Gorelick, Ashkelon (IL); David Azoulay, Jerusalem (IL)

(73) Assignee: XTEND AI Inc., Middleburg, FL (US)

(21) Appl. No.: 18/774,457

(22) Filed: Jul. 16, 2024

Related U.S. Application Data
(60) Provisional application No. 63/527,843, filed on Jul. 20, 2023.

(51) Int. Cl. B25J 9/08; B25J 9/00

(52) U.S. Cl. CPC B25J 9/08; B25J 9/0009

(57) ABSTRACT

A physical connector includes an intelligent locking system (which may further include a mechanical locking system) that operates to connect modules of a modular system that further contains data and power connectors along at least one bus system wherein the internal connectors may be modularized (and broken down into subsets as the data and power connecting lines propagate through the system), wherein the connector includes a transponder capable of communicating with another transponder of a different connector, wherein the transponder holds basic data on the connecting module and connecting modules down the connection line and that basic data is interpreted by a core module with use of a data library.

### CROSS REFERENCE TO RELATED APPLICATIONS

This application claims priority and the benefit of U.S. provisional application 63/527,843, filed Jul. 20, 2023, the disclosure of which is incorporated herein by reference in its entirety.

### FIELD OF THE INVENTION

The present invention relates generally to modular components, and more specifically, to a connector configured to connect various modular components according to a desired application.

### BACKGROUND OF THE INVENTION

Owing to a shortage of qualified workers and high costs associated with maintaining a large workforce, companies are increasingly turning to the use of service robots to improve efficiency and accuracy and to reduce labor costs.

Indeed, the deployment of service robots in various workplaces has increased dramatically in recent years and the resulting increases in workplace productivity and safety have driven a rise in demand and expansion of the market for such robots. Many companies are spending much time and money to develop robots tailored to meet a specific need in a specific industry. First-generation robots developed for narrowly tailored operations, however, such as performing only a single repetitive task, are often limited in the scope of their applicability and usefulness. Other disadvantages of such first-generation robots include:
a) the high cost of developing service robots makes them unaffordable for most enterprises—for example, it takes an average of 3.5 years and $35 million to develop a mobile, autonomous service robot;
b) service robots are designed for a specific application and are not configurable;
c) robots may only function fully when connected to the Internet; and
d) most robots are reactive, limiting their applicability.

Currently, robots are typically developed from the ground up, one model at a time, for a specific deployment. For each new deployment, new hardware and software are developed. This methodology is costly, time consuming and inefficient. Hence, there is a need in industry for modular autonomous robots that may be customized and optimized to perform any task in virtually any industry.

Modular robots consist of interchangeable components, allowing for flexibility in configuration according to the desired application. Efficient and secure connections between these components are crucial for optimal functionality. The present disclosure addresses this need with the connector described herein.

### SUMMARY OF THE INVENTION

The presently described connector for modular systems introduces an innovative solution for efficient and secure connections between modular components. Its unique locking mechanism and integrated electrical connectors enhance the overall performance of modular systems, enabling seamless power and data flow between adjacent modular components.

In an embodiment, the connector is a modular connector that accommodates connections for high-speed data, low-speed data, and power. High-speed connections are essential to manage data-intensive functionalities such as video and audio streams. Low-speed connections can be used to manage data of non-intensive functionalities such as sensor and motor data. However, every connector need not support every possible functionality. Rather, each connector may contain only the connections necessary for its specific module (or the modules propagated further down the line). For example, a connector to a motorized arm module may not contain a high-speed connection if the arm only requires low-speed motor data. Similarly, a connector to a head module may not contain a low-speed data connection if the head module only requires high-speed data for its display screen, speakers, and camera. A torso connector will likely require all types of connections as it must route data and power to all possible modules to which it may be attached.

The connector also has an electrical solenoid locking system to ensure a secure, continuous connection. When locking, solenoids in the female connector will cause a plunger to slide into corresponding grooves in the male connector, locking the two connectors together. The solenoids may be configured as a fail-safe, fail-secure, or memory locking mechanism. Electrical or mechanical overrides to the solenoids may also be provided. The locking and unlocking of the solenoids may be intelligently controlled by the robot's logic or microprocessor module. This intelligent locking capability also allows for limiting the ability to lock/unlock the connectors to known users of a specified authority level. In other embodiments the locking and unlocking of the connector may be controlled by a mobile app or some kind of intelligent timer managed by the robot.

The connector may also be provided with transponders or microchips that can communicate low-level or firmware-level information about the connector. When two connectors connect, the transponder(s) of a first connector can communicate with the transponder(s) of the other connector. Such communication may propagate from connector to connector until it reaches the intelligent base of the robot. Information transmitted by the transponders may possibly include the locked/unlocked status of the connector, the identity of the module to which the connector is attached, functions available to said module, data/power requirements for said module, and an alive signal or failure alert for said module. The transponders may communicate via a serial peripheral interface (SPI) or any other known low-level serial communications protocol.

To achieve these and other objects, embodiments of the invention of this disclosure use smart connector technology in robots to enable a modular construction that can be assembled quickly and with low production costs to customize a service robot for a particular industry or application. It is readily understood that the connectors according to embodiments of the present invention may be used in a number of modular systems, and not just be limited to modular robotic systems. For example, such modular systems may include modular computing systems, for example, where an input module is connected to a processing module, which in turn is connected to an output module. In this way, any of a number of input modules (e.g., keyboard, mouse, camera, etc.) may be connected to any of a number of different processing modules (e.g., different processors, memory, etc.) which in turn may be connected to any of a number of output devices (e.g., display screen, audio output, RF output, wireless output, etc.).

In an embodiment, the present invention is directed to a connector system comprising a first connector operable to connect a first module to a second module; a second connector operable to connect the second module to a third module; wherein the second connector includes connection functionality for the third module, and the first connector includes connection functionality for both the second and third modules.

In a further embodiment, the present invention is directed to a connector for components comprising: a first component having a first cable block with electrical connectors and a second component having a second cable block with corresponding mating electrical connectors; a locking mechanism operable to mechanically mate the first component and the second component; and wherein, the locking mechanism is operable to connect the electrical connectors of the first cable block with the electrical connectors of the second cable block to allow power and data to flow between the first and second components.

In a further embodiment, the present invention is directed to a modular robot having a plurality of interchangeable modules, the robot comprising: a first module having an internal sleeve; a locking mechanism external to the internal sleeve of the first module, and a plunger of the locking mechanism passing through an opening in the sidewall of the internal sleeve; a second module having an externally extending sleeve dimensioned to fit inside the first sleeve, a sidewall of the externally extending sleeve having an opening aligned with the sidewall of the first sleeve and the plunger of the locking mechanism when the externally extending sleeve is fully inserted into the internal sleeve of the first module; and a first cable block with electrical connectors in the internal sleeve of the first module and a second cable block with corresponding mating electrical connectors in the externally extending sleeve of the second module, wherein, when the externally extending sleeve of the second module is fully inserted into the internal sleeve of the first module, the locking mechanism is operable to cause the plunger to move into the sidewall openings of the internal and external sleeves and to hold the sleeves together, and the electrical connectors of the sleeves form an electrical connection through which power and data may flow between the modules.

In a further embodiment, the present invention is directed to a connector for components comprising: a first sleeve associated with a first component; a locking mechanism external to the first sleeve and having a plunger that is operable to protrude through an opening in a sidewall of the first sleeve and extend into the interior of the first sleeve; a second sleeve associated with a second component and dimensioned to fit inside the first sleeve, a sidewall of the second sleeve having an opening in alignment with the sidewall opening of the first sleeve and the plunger of the locking mechanism when the second sleeve is fully inserted into the first sleeve; and a first cable block with electrical connectors in the first sleeve and a second cable block with corresponding mating electrical connectors in the second sleeve, wherein, when the second sleeve is fully inserted into the first sleeve, the locking mechanism is operable to cause the plunger to move into the second sleeve sidewall opening to lock the first and second sleeves together, and the electrical connectors of the first sleeve and the mating electrical connectors of the second sleeve form an electrical connection through which power and data may flow between the first and second components.

### BRIEF DESCRIPTION OF THE DRAWINGS

The various aspects and embodiments disclosed herein will be better understood when read in conjunction with the appended drawings, wherein like reference numerals refer to like components. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices. The drawings are not necessarily drawn to scale and are not in any way intended to limit the scope of this invention but are merely presented to clarify illustrated embodiments of the invention. In these drawings:

FIG. 1 is a diagram of a pair of mating connectors in an unconnected (unlocked) state;

FIG. 2 is a diagram of a pair of mating connectors with an inner sleeve fully inserted into an upper sleeve but with the locking mechanism in an unlocked state;

FIG. 3 is a block diagram showing the slanted surface of a locking mechanism in one embodiment of a connector;

FIG. 4 is a diagram of a pair of mating connectors with an inner sleeve fully inserted into an upper sleeve with the locking mechanism in a locked state;

FIG. 5 is a close up view of the connections between cable blocks in the mating connectors;

FIG. 6 is a diagram of a modular connector;

FIG. 7A is a cross-section view of two connectors locked in place together;

FIG. 7B is a perspective view of the exterior of the locked connectors of FIG. 6A;

FIG. 8 is a block diagram showing the use of connectors in an embodiment of a modular robot;

FIGS. 9A-G illustrate various features and advantages of the connector disclosed herein;

FIG. 10 illustrates an exemplary embodiment of the power and control of solenoids in an intelligent locking system;

FIG. 11 illustrates another exemplary embodiment of the power and control of solenoids in an intelligent locking system;

FIG. 12 illustrates exemplary connection paths in a modular robot; and

FIG. 13 illustrates exemplary cable routing and module connections in a modular robot.

### DETAILED DESCRIPTION OF THE INVENTION

One of ordinary skill in the art would readily recognize that the connectors of the present invention may be applicable and utilized in many different scenarios; however one advantageous application is to modular robots to securely, quickly and efficiently couple together different modules according to the needs of a particular application. It is readily understood that the connectors according to embodiments of the present invention may be used in a number of modular systems, and not just be limited to modular robotic systems. For example, such modular systems may include modular computing systems, for example, where an input module is connected to a processing module, which in turn is connected to an output module. In this way, any of a number of input modules (e.g., keyboard, mouse, camera, etc.) may be connected to any of a number of different processing modules (e.g., different processors, memory, etc.) which in turn may be connected to any of a number of output devices (e.g., display screen, audio output, RF output, wireless output, etc.).

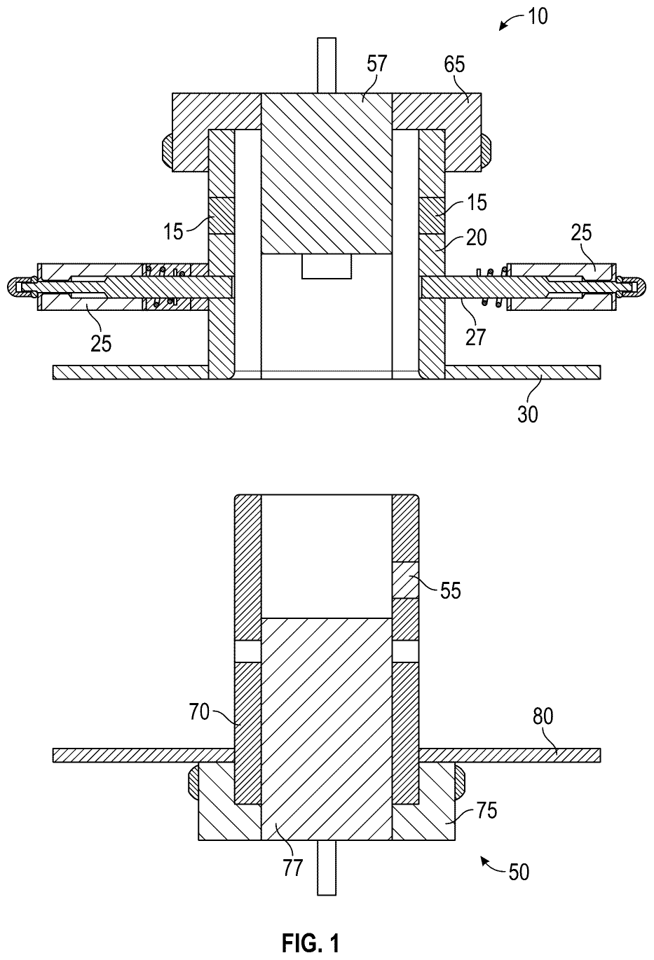

According to an embodiment of the connectors of the present invention, each of a pair of mating connectors is provided with a transponder, a sleeve, a base or flange, and a cable block. FIG. 1 illustrates such an embodiment with an upper (female) connector 10 and a lower (male) connector 50. The designation of the upper connector 10 as female and the lower connector 50 as male is not static and alternative designations are envisioned. Here, the upper connector 10 is provided with an upper transponder 15 and the lower connector 50 is provided with a lower transponder 55. Transponders 15, 55 include small microchips or microcontrollers capable of performing low-level or firmware-level communication regarding their respective connector when connected to a transponder of another connector.

The upper and lower connectors 10, 50 are further provided with an upper sleeve 20 and lower sleeve 70, respectively. In this embodiment, the upper connector 10 is female, and thus the upper sleeve 20 is housed entirely within an upper shell 30 of its associated module. Conversely, because the lower connector 50 in this embodiment is a male connector, the lower sleeve 70 and the lower cable block extend 77 beyond the lower shell 80 of its associated module. In other embodiments, the sleeves may be keyed or have a notch or the like to ensure the proper orientation of the connection.

The upper and lower connectors 10, 50 additionally are provided with an upper flange 65 and a lower flange 75, respectively. The upper flange 65 or lower flange 75 help secure the connector firmly in place and are located within the respective upper or lower shell 30, 80.

An upper cable block 57 and lower cable bock 77 are also provided in the respective upper and lower connectors 10, 50. The cable blocks 57, 77 contain all the power and data cables that must be connected to one another for the associated modules to function. The cable blocks 57, 77 may include USB, HDMI, CAN bus or other types of data or network cables.

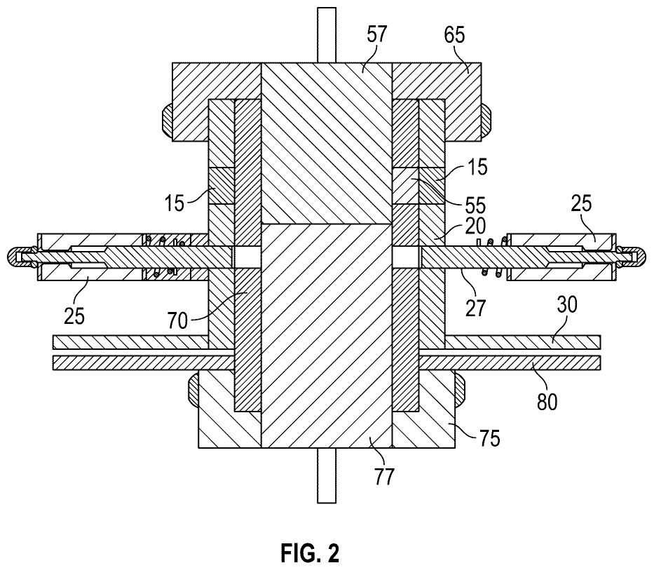

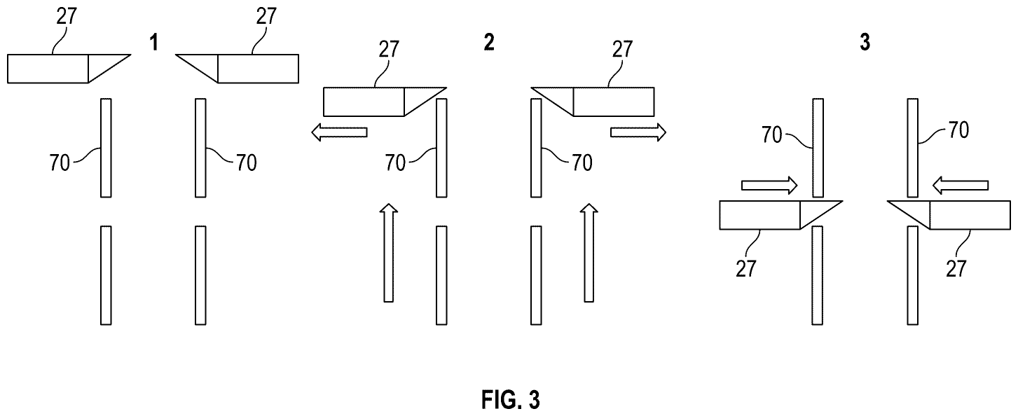

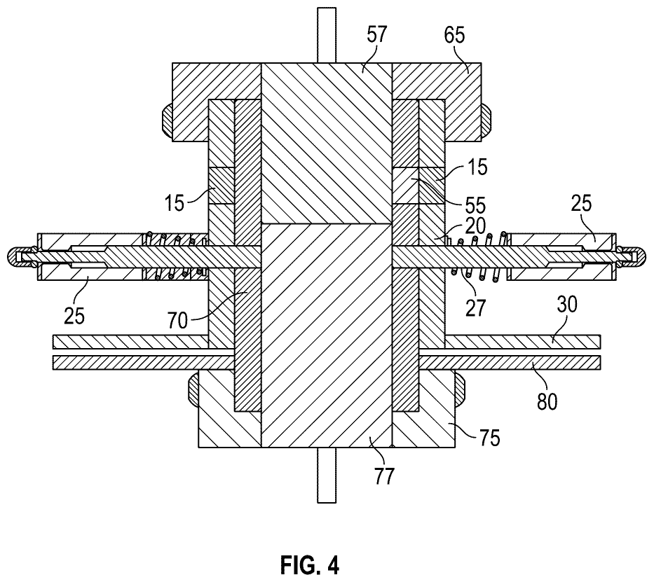

FIG. 2 shows the upper and lower connectors 10, 50 engaged in a mated state with the lower sleeve 70 fully inserted into the upper sleeve 20. Here, the upper connector 10 contains at least one solenoid assembly 25 secured by a bracket or the like to the upper sleeve 20. When the connectors 10, 50 are in a mated state, i.e., when the lower sleeve 70 is fully inserted into the upper sleeve 20, a plunger 27 of the solenoid assembly 25 may operate to extend outward so as to protrude through an opening in the sidewall of the upper sleeve 20 and engage a correspondingly aligned groove in the lower sleeve 70 to physically secure the connectors 10, 50 together. The plunger 27 may also operate to retract from the groove in the lower sleeve 70 and the opening in the upper sleeve 20 to allow the connectors 10, 50 to disengage. FIG. 2 shows the connectors in an unlocked state with plungers 27 retracted, while FIG. 4 shows the connectors in a locked state with plungers 27 extended to engage the groove in the lower sleeve 70.

In this manner, the solenoid assembly 25 and its plunger 27 function as a locking or unlocking mechanism. The locking/unlocking mechanism may also include an electrical means to cut power and/or data from flowing through the connectors.

The solenoid assembly 25 (and plunger 27) may be configured as a fail-safe, fail-secure, or “memory” locking mechanism. In a fail-safe configuration (power is necessary to insert the plungers and lock the mechanism) the connectors are unlocked by default (when no power is available), while in a fail-secure configuration (power is necessary to remove the plungers and unlock the mechanism) the connectors are locked by default (when no power is available).

In a fail-safe embodiment, a separate traditional mechanical or electrical lock may also be included to prevent unwanted or unsafe disconnection. For example, in the case of a modular robot, such a mechanical or electrical lock would prevent the accidental detachment of the head or other modular component of the robot. Examples of mechanical locks that can be integrated into the connector include a clip, buckle, or a traditional lock and key arranged along the exterior of the connector.

In a fail-secure embodiment, it may be desired to provide a relay, switch, or the like to cut power in case of an electrical emergency, even while the cable blocks remain physically connected. Some embodiments may also include a mechanical override to the lock so that a modular robot, for example, can be disassembled without power. Additionally, a mechanical override may also be provided for assembling the robot. Because the connectors are locked by default in a fail-secure configuration, each module may automatically be in a locked state prior to being attached to the robot. In such a case, a means to open the solenoid must be provided to allow the connectors to be connected. In an alternative embodiment, the power connection/control connection to the system or the solenoid may be loose and thus allow connection without the full unlocking of the connector.

In some embodiments, a switch or relay and an associated control mechanism may also be provided to enable or disable the flow of power and/or data according to user wishes or to operate in emergency situations. For example, if a modular component is configured as “fail-secure”, where connections are locked by default, it may be desired to cut power while allowing the cables to remain in a connected state in the case of a power surge.

A “memory” locking embodiment functions similarly to a traditional lock and key in which the solenoid remains in its current locked (or unlocked) state until expressly changed. Thus, like a traditional lock, the solenoid remains locked until unlocked, and then will remain unlocked until locked.

FIG. 3 shows an alternative embodiment in which the solenoid plunger shape has a bevel or inwardly slanting surface that allows a fail-secure solenoid to physically secure the upper and lower sleeves together while in an unpowered state. This can occur by the lower sleeve 70 physically pressing against the slanted surface of the solenoid plunger and causing the plunger 27 to retract as the lower sleeve advances upward until the lower sleeve is fully inserted and at which time the solenoid plunger mates with the grooves in the lower sleeve and snaps or latches into place. At this point, the solenoid assembly will have power and control and will be able to properly use the intelligent locking system. In this embodiment, the solenoid is fail-secure, meaning that it is in a locked position when there is no power. The slanted design of the lower sleeve 70 allows the connectors to slide into place even without power. Once they are connected, the plunger snaps into place and power can then be provided throughout the system due to the connection of the upper and lower cable blocks.

Returning to FIGS. 2 and 4, it can be seen that an upper transponder 15 may be provided on both the left and right sides of the upper sleeve 20, while a single lower transponder 55 is provided on only one side of the lower sleeve 70. When the lower sleeve 70 is fully inserted into the upper sleeve 20 the lower transponder 55 aligns with one of the upper transponders 15. FIGS. 2 and 4 show the lower sleeve 70 fully inserted into the upper sleeve 20 with the lower transponder 55 aligned next to the right-side upper transponder 15. Because there is only a single transponder 55 on the lower sleeve 70, the connectors 10, 50 are able to track their relative orientation by detecting whether the lower transponder 55 is connected to either the right- or left-side upper transponder 15.

Additionally, FIGS. 2 and 4 also show that when the upper and lower connectors 10, 50 are engaged in a mated state the cable blocks 57, 77 containing power and data cables are also connected to one another. This is the main connection for data and power flow between modules.

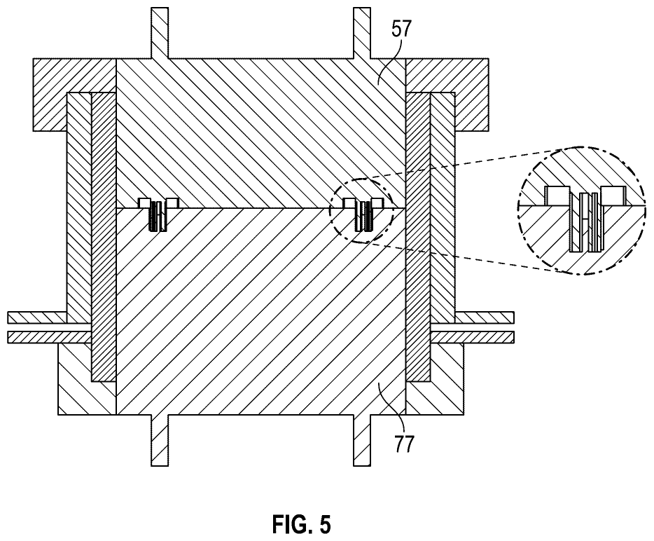

FIG. 5 shows in greater detail the connections between cable blocks 57, 77. In some embodiments (not shown), the cable blocks may be configured to be rotationally symmetric so that they may be connected to one another without concern for their respective orientations. Within the cable blocks, the cables may connect with one another in a manner similar to conventional electrical cords or connectors.

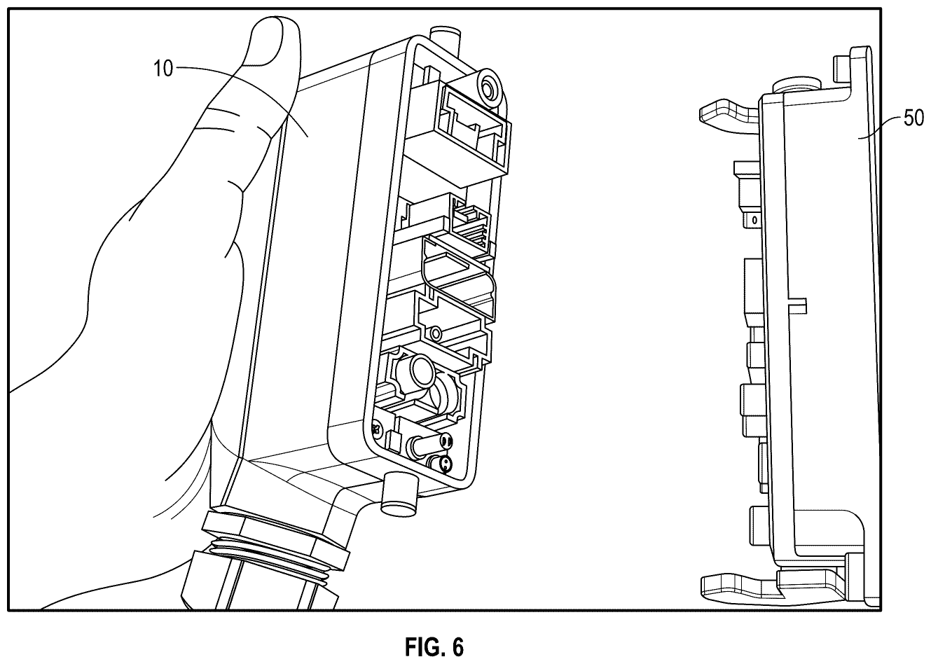

The cable blocks may also be configured as modular connectors. Modular connectors provide a high degree of connectivity and manufacturing flexibility. With a modular connector, multiple types of connections, including electrical, optical, signal, and gaseous connections can be incorporated into a single assembly. FIG. 5 shows an exemplary embodiment in which the modular connector includes an HDMI connection. Regardless of whether the cable blocks include connections for Ethernet, USB, CAN bus, etc., all can be integrated into a standard Modular Connector. Manufacturers of conventional modular connectors include Samtec, Han-modular, and Staubli. An example of a conventional modular connector is shown in FIG. 6

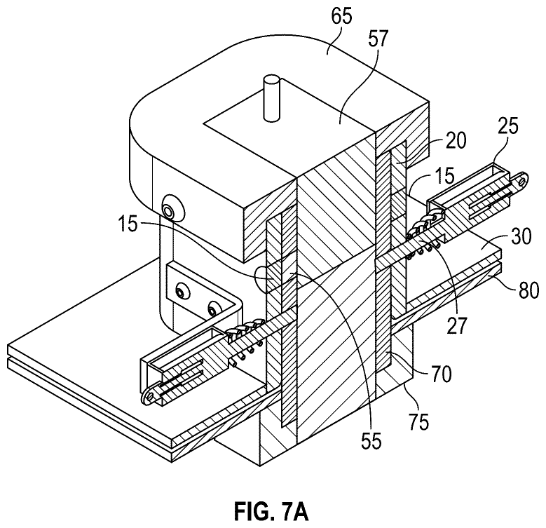

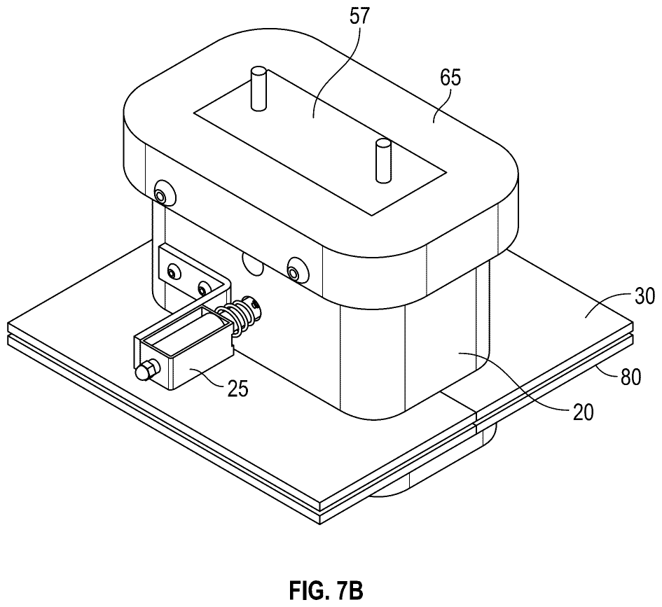

FIG. 7A shows a cross-sectional view of the connectors 10, 50 locked together. As can be seen, when the connectors are fully engaged and locked together all components of the connectors are housed internally to the upper and lower shells 30, 80 of the associated module. Thus as shown in FIG. 7B, when connected, the connectors themselves are not visible or exposed to the exterior.

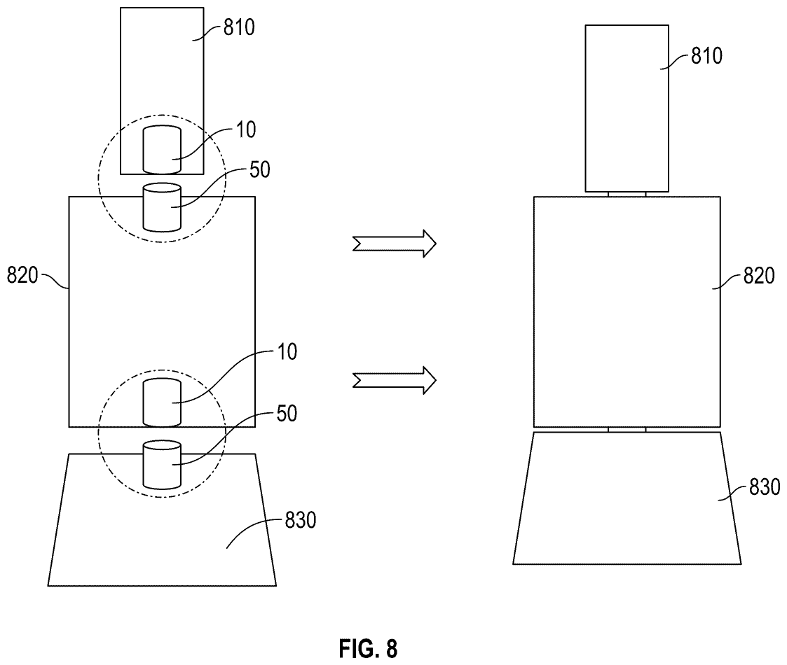

In an embodiment of a modular robotic system, as depicted in FIG. 8, connectors 10, 50 may be used to connect a head module 810 and a torso module 820, and also to connect torso module 820 and base module 830, for example. In the embodiment shown, a first male lower connector 50 on top of the base 830 aligns with a first female upper connector 10 in the torso module 820 and a second male lower connector 50 on top of the torso module 820 aligns with a second female upper connector 10 in the head module 810. The respective male and female connectors 50, 10 slide together and when connected little to no part of each connector will be visible from outside the robot. In alternative embodiments which the connectors may engage at different angles.

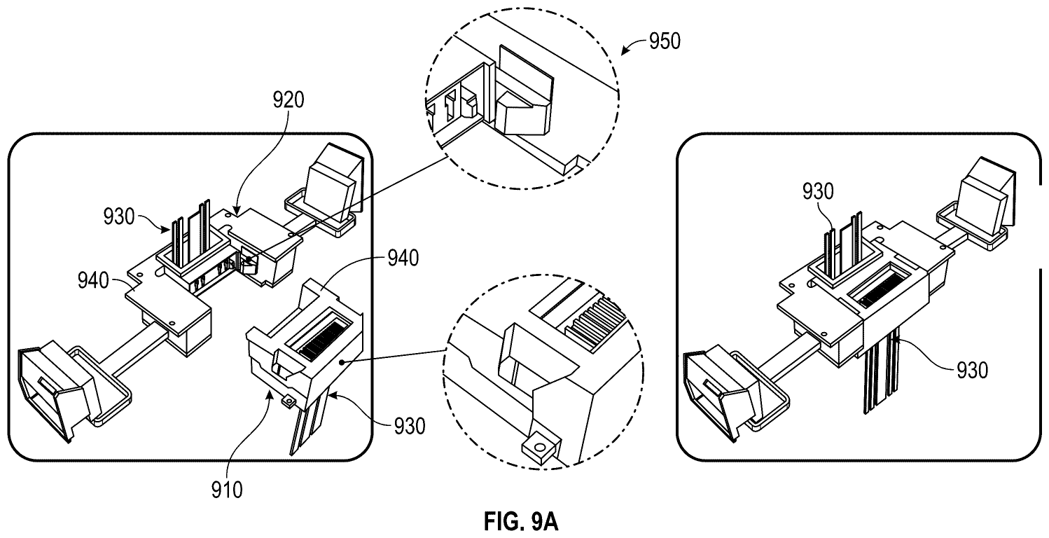

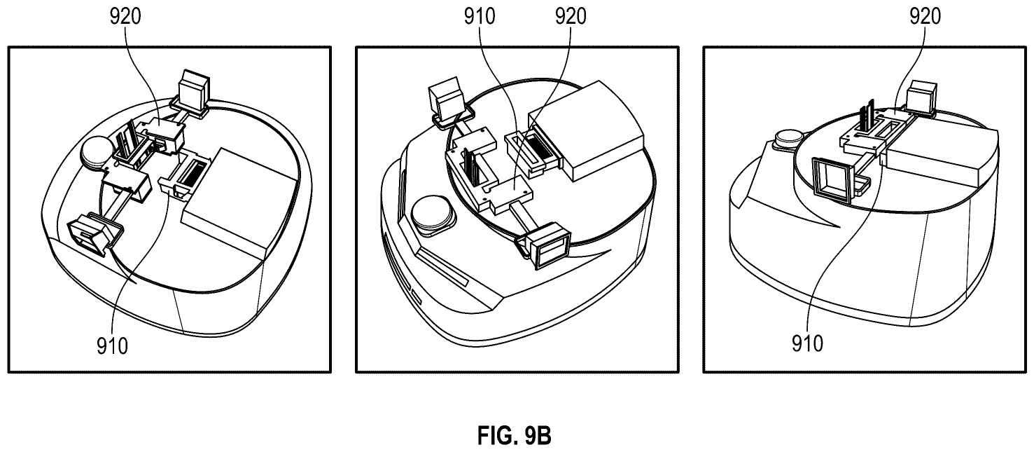

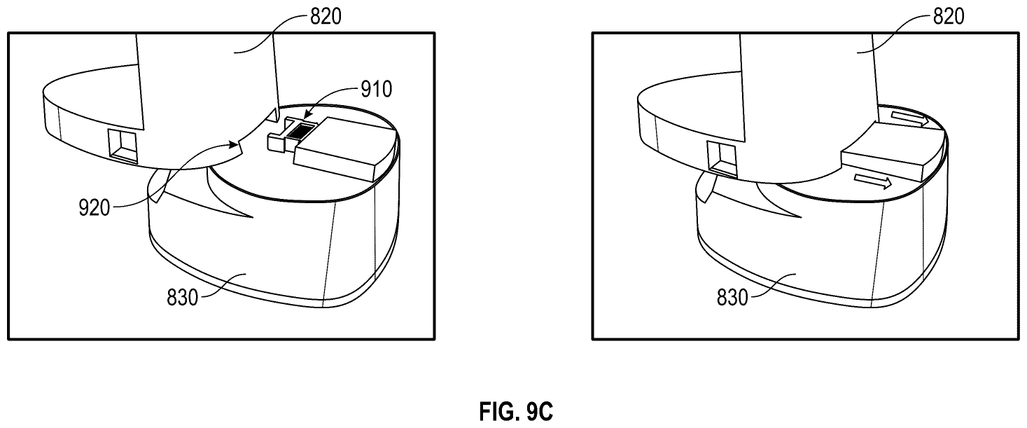

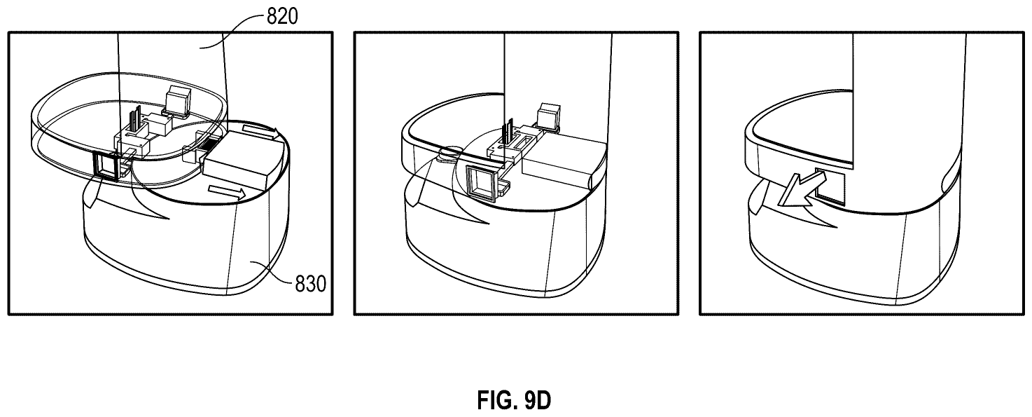

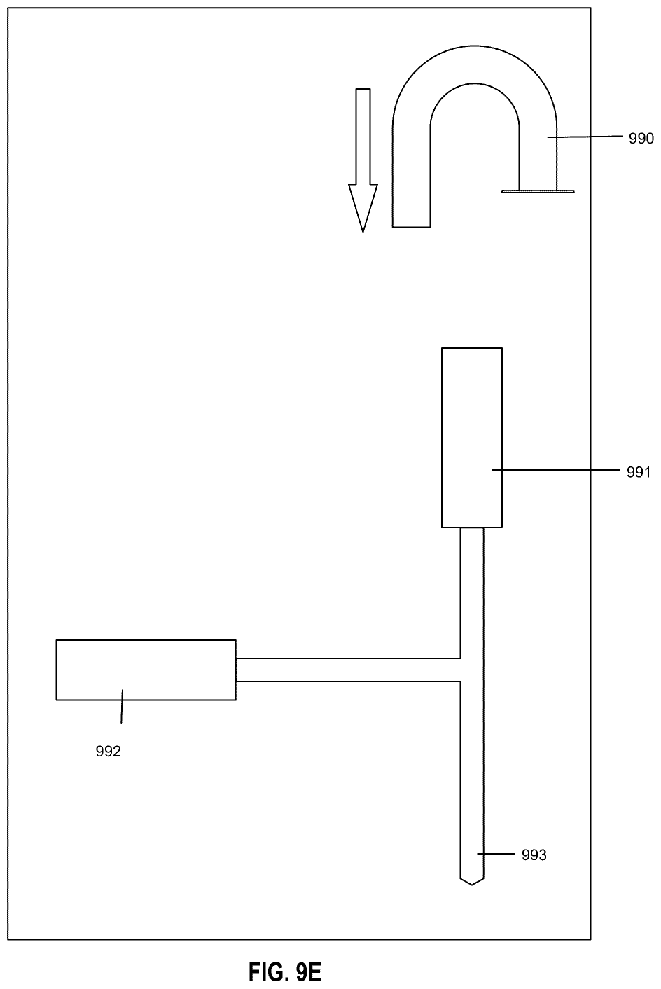

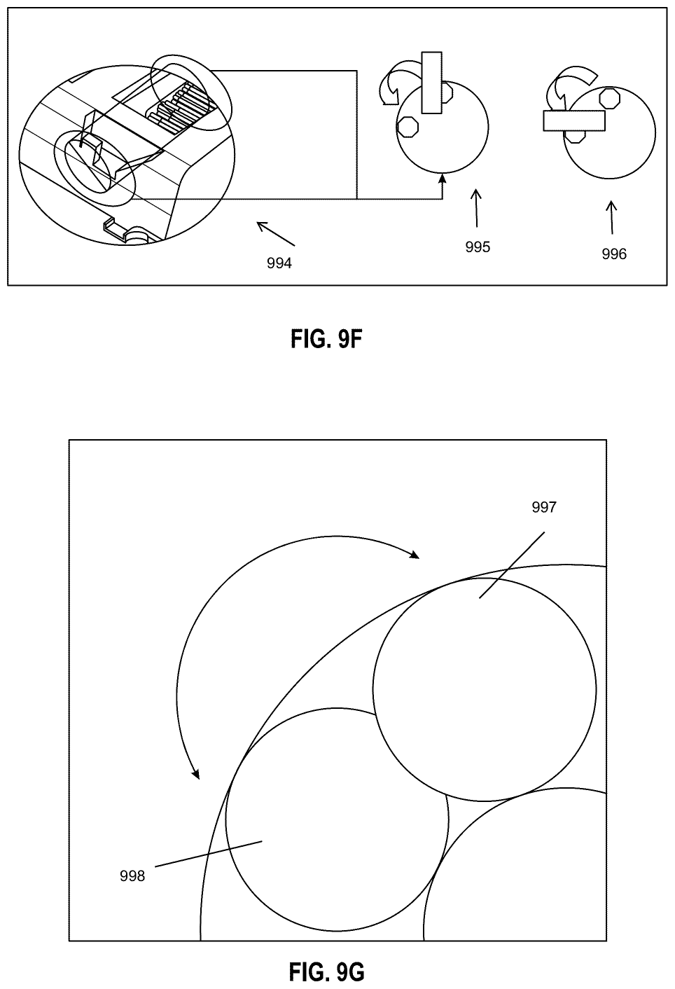

FIGS. 9A-D show another embodiment of the connectors used in a modular robot assembly. FIG. 9A shows male and female connectors 910, 920 connecting without being attached to any module. In FIG. 9A, the male connector 910 is analogous to the aforementioned lower connector 50, while the female connector 920 is analogous to the aforementioned upper connector 10. The cable harness 930 attached to the male connector 910 is analogous to the cable blocks 57, 77 described above, except the cable harness 930 bends at a right angle as the cables come out of the connection point. The cases 940 for the connectors are analogous to the sleeves 20, 70 described above. Transponders (not shown) may be integrated into this embodiment in the same way as described above. A locking tongue 950 enables the connectors to snap or latch together in a locking engagement and is analogous to the solenoid assembly 25 described above, with an additional possibility of manual locking/unlocking. The locking tongue 950 may also include handles at either end. The handles may be pulled apart to disengage the male tongue portion from its corresponding female engaging counterpart to allow for disconnection. The tongue 950 may have varying length sides to allow the handles to be grasped on modules of varying size. In certain embodiments, the tongue 950 may be powered to enable the intelligent locking features described herein. The connector assemblies may be provided with tongues of various interchangeable sizes to fit with different smaller-sized modules. The connector upper sleeve and lower sleeve are shown in a horizontal orientation, but they may also optionally be configured in a vertical configuration, as needed for a particular application.

FIG. 9B shows the male connector 910 sliding into and locking with the corresponding female connector 920. FIG. 9C shows an outside view of a torso module 820, with a female connector 920, sliding onto and latching into place with a base module 830 that has a male connector 910. FIG. 9D shows a translucent view of how the connector components of the torso 820 and the base 830 latch together in the horizontal plane as the torso module 820 is attached to the base module 830. The final configuration of the base and torso modules locked together is shown with an opaque view and an arrow highlights the ability of the tongues to be manually separated for disassembly.

FIG. 9E illustrates a block diagram of the cable harness 930 having wires or cables 993 which may extend and connect to vertical pins 991 or horizontal pins 992, which are situated generally perpendicular to each other, along with an optional cap 990 which can be used to cover certain pins which are not in use. For example, in FIG. 9E, the horizontal pins 992 are being used, but the vertical pins 991 are not being used, so the optional cap 990 may be used to cover the vertical pins 991. This approach allows the use of the cable harness 930 in either a vertical or horizontal orientation.

In an alternative embodiment illustrated in FIG. 9F, multiple orientation options may be achieved using only one set of pins. The internal structure of the sleeve may contain a housing having a rotating body, which may be rotated to a vertical orientation as body 995, or alternatively may be rotated to a horizontal orientation as body 996. The rotating body can house the pins of the various wires and cables. The rotating body may be provided with a tab (see 994) to allow a user to grab and twist the rotating body between the vertical and horizontal orientations. Internally, the rotating body may a small protrusion which may be used along with an indented track to guide the rotation between the vertical and horizontal orientations, to maintain a desired degree of rotation. FIG. 9G illustrates the rotating body in a vertical position (997), as well as in a horizontal position (998).

### Intelligent Locking Mechanism

The locking/unlocking mechanism described above may be considered a lock that intelligently opens or closes a lock based on security features such as face recognition, voice recognition, or general identification that go beyond the standard lock and key locking system, such as PIN codes, username, password, and the like. For example, when a robot is in communication with a software system such as a connected website, portal, domain, a phone app, a designated key device, etc. the software system or device can be used for face recognition, voice recognition, or for entering a fingerprint, code, pin, password, pattern, etc. as a means of authorization recognition. The lock mechanism may open and close via communication with these devices, for example, over Bluetooth, Wi-Fi, or a network, etc. An authorization application may alternatively run on the robot itself via, for example, a touch screen, fingerprint scanner, camera, microphone, etc.

In other embodiments an additional locking system may operate in tandem with an electronic locking system. The additional locking system may be a simple physical locking system such as a clip or buckle placed along the connector to physically hold the device (module) in place regardless of the locked or unlocked state of the solenoid. The additional locking system may also be configured as a secure locking system that requires a key component and holds the device in place regardless of the locked or unlocked state of the solenoid.

In a disassembling operation, different levels of authority may be required to separate the various modules according to the criticality of their respective functions. For example, when disassembling a modular robot, removing a “light connector” to an auxiliary-type module may require a different access level than removing a “heavy connector” to a more central module to the robot design.
A. “Heavy” connectors will include a superset of all or most possible connections and may accommodate universal “image”, “motor”, “audio”, “screen”, etc. buses throughout the modular robot. A heavy connector may be used for multiple types of connections, such as image and motor devices, which may be connected by way of a single heavy connector. For example, all devices containing an “image” connector (USB or HDMI) may be connected in parallel via a torso module or other module having a “heavy” connector. These connections will constitute an “image” bus through which all image data is communicated on the robot. In some embodiments, different connection types (i.e., connections for “image” and “motor” signals) may require physically different connections (CAN bus for motor, USB for data, etc.), making it simple for the base to control which bus is used to broadcast messages.
B. “Light” connectors will only provide a subset of the connections available with “heavy” connectors (for example, an arm module may only have a CAN bus for its motor, while the head module will only have a USB). Messages may be broadcast from the base to all modules via a bus (i.e., image, motor, or sound bus), and only a specific module on the bus will respond. For example, the head module won't receive messages designated for the arm module because the head module has only a USB cable and the arm has only a CAN bus cable.

Removal of a light connector may require a general technician while heavy connectors may require high-level technicians. For instance, a regular maintenance worker may be authorized to remove and replace an air filter module, but a technician with higher-level access may be needed to remove a torso module, and an even higher-level of access may be required to remove the core module base. In the case of replacing one core module and one apparatus/accessory module, removal of the modules may require permission from the lowest-level module and/or the highest-level module in the connection. In the case where two or more modules of different access level (e.g., a core module requiring high-level access and an accessory module requiring lower-level access) are being removed at once, the access level required to perform the procedure can be determined by either the lower-level or higher-level module. In some cases it may be beneficial to be more permissive and allow someone with a lower level of permission to remove a higher level of permission core module they otherwise would not have authorization for.

In some embodiments, the modules themselves may have a preset authority level required to unlock the associated connector. This preset authority level may be dictated by a code on the transponder. Authority levels may be customized by the manufacturer, the customer, the owner, the technician, etc. Customization in the case of known user data such as face recognition and voice recognition data can be as specific as an individual user. In other embodiments, the connector locks may be configured to lock or unlock after a certain period of time has passed or a certain time has been reached. The connector locks may also be set to lock or unlock automatically when a battery reaches a predetermined charge percentage, such as 3%.

Intelligent locking may operate as a function of the modules and components available to a modular robot. For example, the head module may contain cameras and microphones, and an arm module may contain a fingerprint scanner. If the modular robot is connected to an arm module but no head module, intelligent locking can be activated using the fingerprint scanner on the arm module. Conversely, if the head module is connected but not the arm module, intelligent locking can be activated using facial and voice recognition.

Once an authorized user begins the process of disassembling the robot, the appropriate locks will remain unlocked even after modules containing components requiring authorization have been removed, without the need for re-authorization. For example, if an authorized user specifies the removal of the head module and arm module of the robot, that authorized user can first remove the head, which may contain the components required for authorization such as a camera, microphone, etc., and the arm will remain unlocked despite the fact that there is no longer a means to identify the current user.

### Embodiments of Intelligent Locking Mechanism

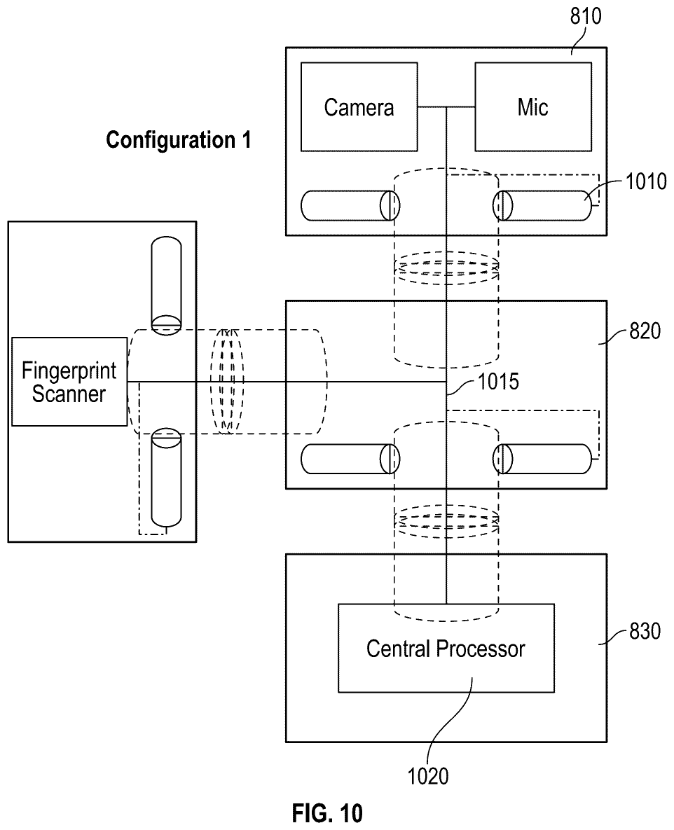

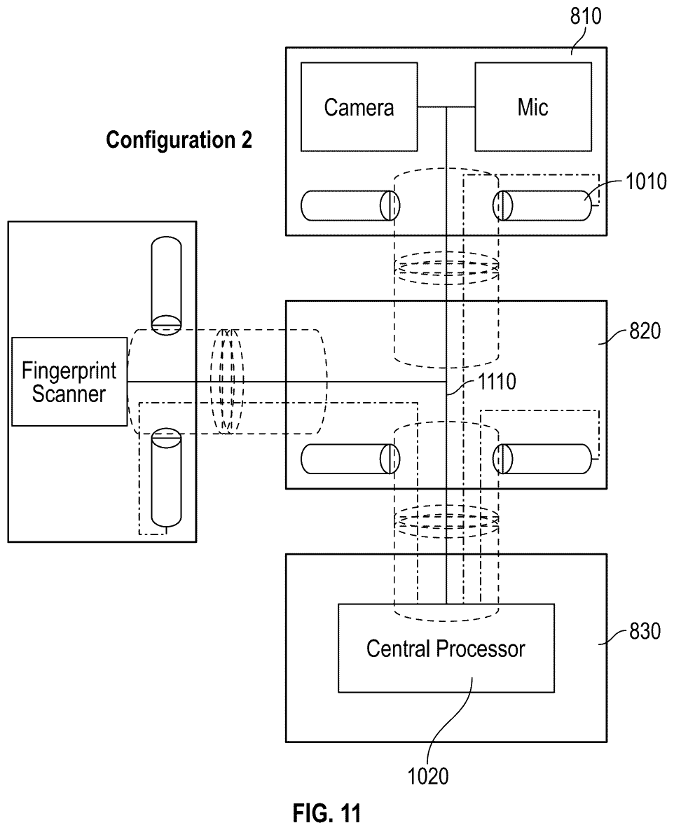

Two exemplary embodiments of the intelligent locking system are described below. In the following embodiments for power and control of solenoids as shown in FIGS. 10 and 11, for clarity only one solenoid is shown as connected to the system control lines. But in an actual application, both solenoids may be connected to the system control lines. The two solenoids may share the same data and power lines.

FIG. 10 shows a first embodiment in which the solenoids 1010 are controlled from a centralized location, i.e. the base 830. In FIG. 10, power for the solenoids is provided via the power pins of the cable block. The power and control lines for the solenoids connect to the same power and data bus as all other the components of the robot. A CAN bus 1015 may be used to implement this connectivity. Via the CAN bus 1015, a central processor module 1020 is operable to open (unlock) or close (lock) any specific solenoid with a multiplexer/demultiplexer, for example.

FIG. 11 shows a second embodiment in which the solenoids 1010 are controlled from specialized or dedicated pins on the connector itself. Here, the solenoids 1010 may be powered and/or controlled by the central processor 1020 via an independent network 1110. The solenoids 1010 may be powered by their own dedicated power source residing either in the central processor module 1020 or by a separate battery.

An alternative embodiment may only require power to be provided directly to the solenoids, where the presence or absence of power will dictate the locking or unlocking of the system. Furthermore, a toggle, such as a switch between a buffer or NOT gate, may be used to switch between fail-safe and fail-secure modes.

### Transponder to Transponder Communication

The transponders may be configured to reference a data library and transmit simplified data as disclosed in published patent applications GB2598049 and US20230001570, titled “Modular Frame for an Intelligent Robot” by H. Fox et al., the contents of which are incorporated by reference herein. The data library is a library of all (or the most) needed features and functions of all (or most) modules. The transponder may provide the connectors with such information as: (1) the type of module being attached; (2) the manner of attachment of the module (with assistance from a non-symmetrical lower transponder); (3) the site where the module is being attached (creating a linked list of connections, for example); (4) the prescribed functions that that the module provides (including module data, data protocols, power requirements, etc.); (5) the purchased/prepaid optional functions to which the module has access; (6) the design data associated with the module (for example, the company logos of 1^{st}, 2^{nd}, and 3^{rd} party developers); and (7) verification data attesting that said module is property licensed and neither pirated nor unlicensed. The connections established by the connectors will communicate such verification data to core module(s) which may look-up this information from the data library and respond appropriately to allow the firmware and OS to function properly with all the robot's modules.

The data transmitted by the transponders may be in raw data format or configured and encoded. Moreover, the data itself can be stored in various standard ways known in the art, examples of which include:
a code for each piece of information where a number represents a specific predefined component;
a code for each piece of information where a number represents a specific predefined component or function when segmented;
a larger set of codes that may contain detailed data on the components and functions that does not require predefined numbers representing a specific component or function; and
a set of data that, knowing the data library, holds information on location(s) within the data library that are important for the functional use of the module and the modules component specifics.

Transponder communication may be implemented via a serial peripheral interface (SPI) or other standard serial communications protocol. With SPI, multiple “slave” devices (module transponders) may communicate with a “master” (base transponder) in a network. New devices/connectors may be added to the existing network. SPI also allows for self-testing, holding data needed for the transponder, and for diagnostics.

SPI may also be used to control the solenoids in the aforementioned two embodiments for power and control of solenoids. SPI may be implemented via USB or any data pins. Alternatively, dedicated pins may be configured to handle their own logic.

### Modular Connectors for a Modular Robot

The modular connectors may contain high-speed and/or low-speed buses.

Examples of high-speed buses that may be used include USB and Power Over Ethernet (PoE). At least one high-speed bus is required in applications that use image data. An Ethernet-based bus is less cost-effective but may have advantages with daisy chaining. A PoE bus is a single protocol that allows power and data to be sent together. The PoE bus can handle both low- and high-speed transmissions, but it is not the most cost-effective solution. Additionally, HDMI over Ethernet or HDMI over USB buses may be used.

Examples of low-speed buses that may be used include the CAN bus, UART, and RS-485 buses. Low-speed buses may optionally be used to assist in communicating with large numbers of low data-intensive sensors and components. Low-speed communication can also be used for the identification of each module (via a transponder). In some embodiments, a CAN bus may be utilized advantageously to transmit sensor data without causing bottlenecks on the USB. In alternate embodiments the transponder may be configured as just another device on a USB bus (see FIG. 10, centralized configuration 1).

The protocols for data, as it propagates through the system, may employ backward-compatible technology. This may help reduce costs by avoiding overengineering with more expensive technology than required. For example, a USB2 bus may connect the head module to the torso module, and a USB3 bus may connect the torso module to the base.

“Light” connectors will only provide a subset of the connections available with “heavy” connectors (for example, an arm module may only have a CAN bus for its motor, while the head module will only have a USB). Messages may be broadcast from the base to all modules via a bus (i.e., image, motor, or sound bus), and only a specific module on the bus will respond. For example, the head module won't receive messages designated for the arm module because the head module has only a USB cable and the arm has only a CAN bus cable.

Multiple devices may be connected to the same bus via parallel data lines. For example, motor devices A, B, and C may all connect in parallel to a torso module. These connections will form a “motor bus” on which all motor commands from the base will be broadcast. Devices A, B, and C will receive all messages broadcasted on the bus, but only the selected device or a selected subset of devices will respond. The connectors may also house cooling fluid, hydraulics, compressed air, etc.

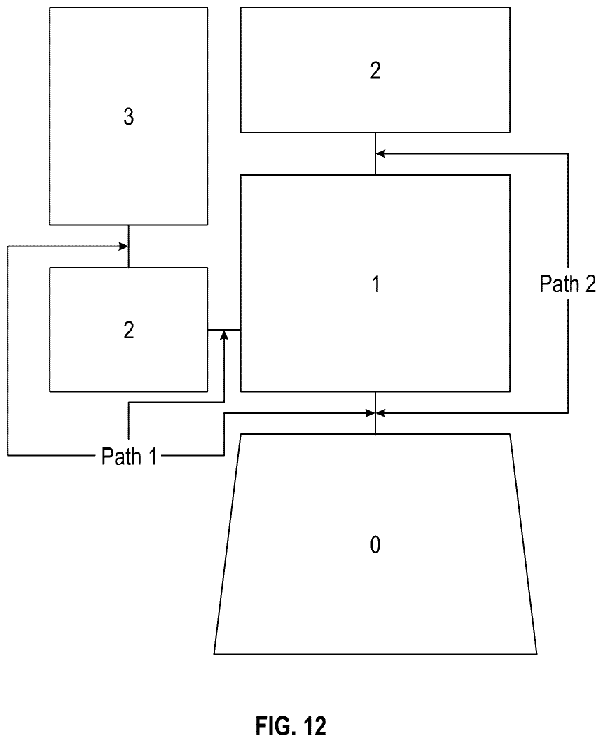

Each degree of connection farther from the core or base of the modular robot may contain a superset of the proceeding higher order degrees of connection down the modules line. For example, FIG. 12 shows two connection paths: path 1 (arm) connecting modules 3-2-1-0 and path 2 (head) connecting modules 2-1-0. Here, the modular connector between modules 0 and 1 contains a superset of all the individual connectors required down both paths 1 and 2 (being equal or greater than all proceeding connectors in the number of connections required). The modular connector between modules 2 and 1 in path 2 contains a subset of all the connectors required in the connector linking modules 0 and 1. The modular connector between modules 2 and 1 in path 1 contains a subset of all the connectors required in the connector linking 0 and 1 and a superset of all the connectors required in the connector linking modules 3 and 2. The modular connector between modules 3 and 2 is a subset of the modular connectors required in the connector linking modules 2 and 1 in path 1 which itself is a subset of the modular connectors required in the connector linking modules 1 and 0. In this embodiment, the connectors themselves, for example a USB connector, may need to also contain a superset of the connectors (USB connectors in this example) down the line as opposed to those running along the same line. In the case where a single USB cable runs between modules 0 and 1, but a different USB cable runs between modules 0 and 2, the connector between modules 0 and 1 must contain not only the USB connections required for modules 0 and 1 but also the additional USB connections required for modules 0 and 2.

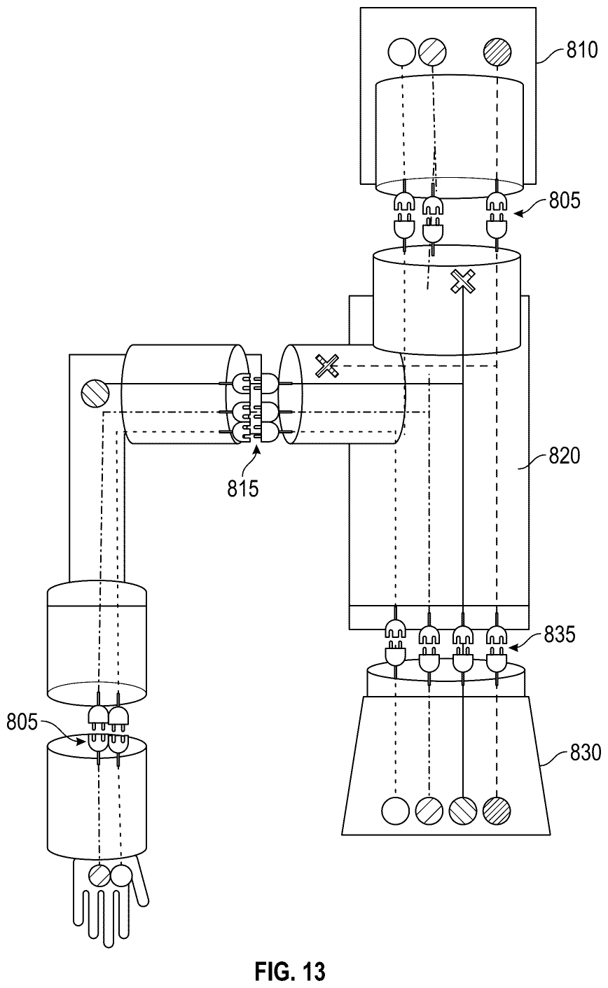

FIG. 13 is an exemplary embodiment of cable routing and module connections in a modular robot, containing components such as a CPU, camera, microphone, etc. As the distance between each connector and the base increases, each connector will contain a smaller subset of the total number of connections, e.g., the base has four total connections 835 the head and arm modules have three connections, 825 and 815, respectively, and the hand module has two connections 805. An “X” represents a stopping point for a data/power line, in which a given data/power line is present within a module but only needs to be passed over to one of the two connectors. Specifically, an “X” represents a stopping point for a data/power line, in which a connector that contains a given data/power line is paired to another connector that does not contain that data/power line, thus the data/power line stops at that point.

### CAN Bus

A CAN bus is a message-based communication protocol and structure, designed originally for multiplex electrical wiring. It functions like a central nervous system in that it allows nodes (sensors, components, etc.) to communicate along a central communication line. Because each element has its own identifier or address, any data sent over the shared line is able to reach its specific target node.

Additionally, a CAN bus can easily prioritize nodes in order of importance. Thus, messages may be propagated along a universal bus (described in further detail below) and in the modular connector section. A CAN bus is suitable for providing a universal data bus for all low-speed communications (basic sensor and motor communications). All nodes in a CAN bus receive messages but only the intended recipient will respond to a message. A CAN bus provides the following advantages:
allows for easy daisy chaining as new modules are added;
enables specific modules to be targeted and sent data, or requested to receive data (including basic motor commands such as torque/position commands); and
may be used for failure handling.

A CAN message has the following basic structure.

TABLE 1
CAN Message Structure

| | | | | | | | | | | |
|---|---|---|---|---|---|---|---|---|---|---|
| SOF | 11-bit | RTR | IDE | r0 | DLC | 0 . . . 8 Bytes Data | CRC | ACK | EOF | IFS |
| | Identifier | | | | | | | | | |

The main components of a CAN message are the 11-bit Identifier and 9-bit Data. The Identifier indicates the system node for which a particular message is intended. The Data is the actual payload of that message.

Those skilled in the art will recognize that the present invention has many applications, may be implemented in various manners and, as such is not to be limited by the foregoing embodiments and examples. Any number of the features of the different embodiments described herein may be combined into a single embodiment, the locations of particular elements can be altered and alternate embodiments having fewer than or more than all of the features herein described are possible. Functionality may also be, in whole or in part, distributed among multiple components, in manners now known or to become known.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. While there has been shown and described fundamental features of the invention as applied to exemplary embodiments thereof, it will be understood that omissions and substitutions and changes in the form and details of the disclosed invention may be made by those skilled in the art without departing from the spirit of the invention. Moreover, the scope of the present invention covers conventionally known, future developed variations and modifications to the components described herein as would be understood by those skilled in the art.

### COMPONENT LIST

10: upper (female) connector
15: upper transponder
20: upper sleeve
25: solenoid assembly
27: plunger
30: upper shell
50: lower (male) connector
55: lower transponder
57: upper cable block
65: flange
70: lower sleeve
75: base
77: lower cable block
80: lower shell
910: male connector
920: female connector
930: cable harness
940: case
950: locking tongue
1010: solenoid
1020: central processor module

We claim:

1. A connector for components comprising:
a first sleeve associated with a first component;
a locking mechanism external to the first sleeve and having a plunger that is operable to protrude through an opening in a sidewall of the first sleeve and extend into the interior of the first sleeve;
a second sleeve associated with a second component and dimensioned to fit inside the first sleeve, a sidewall of the second sleeve having an opening in alignment with the sidewall opening of the first sleeve and the plunger of the locking mechanism when the second sleeve is fully inserted into the first sleeve; and
a first cable block with electrical connectors in the first sleeve and a second cable block with corresponding mating electrical connectors in the second sleeve,
wherein, when the second sleeve is fully inserted into the first sleeve, the locking mechanism is operable to cause the plunger to move into the second sleeve sidewall opening to lock the first and second sleeves together, and the electrical connectors of the first sleeve and the mating electrical connectors of the second sleeve form an electrical connection through which power and data may flow between the first and second components.

2. A connector according to claim 1 wherein an end of the plunger operable to protrude into the interior of the first sleeve has an inwards slant portion, and wherein as the second sleeve is inserted into the first sleeve, the second sleeve physically presses against the slant portion of the plunger protruding into the first sleeve so as to deflect the plunger outward through the opening in the first sleeve and away from the second sleeve until the second sleeve is fully inserted into the first sleeve and the plunger is operable to return inward through the second sleeve sidewall opening in the second sleeve.

3. A connector according to claim 1, wherein the locking mechanism includes a latching solenoid secured to the first sleeve, and energizing the latching solenoid causes the plunger to move out of the second sleeve sidewall opening and to unlock the first and second sleeves from each other.

4. A connector according to claim 3, wherein an end of the plunger of the latching solenoid has an inwards slant portion, and wherein as the second sleeve is inserted into the first sleeve, the second sleeve physically presses against the slant portion of the plunger protruding into the first sleeve so as to deflect the plunger outward through the opening in the first sleeve and away from the second sleeve until the second sleeve is fully inserted into the first sleeve and the plunger is operable to return inward through the second sleeve sidewall opening in the second sleeve.

5. A connector according to claim 1 further comprising: at least one transponder associated with the first component and at least one transponder associated with the second component, wherein the transponders are operable to communicate with each other.

6. A connector according to claim 1 further comprising: first and second mounting elements securing the first and second sleeves to respective adjacent modular components.

7. A connector according to claim 6, wherein the first mounting element includes a flange on the first sleeve and the second mounting element includes a base on the second sleeve.

8. A connector system comprising:
a connector according to claim 1;
a scanning device operable to scan a feature of a prospective user to generate scan information and transmit said scan information electronically to the connector;
a memory for storing scan information of features of authorized users of the connector; and
a control unit operable to compare scan information with the stored scan information in the memory, and if a matching feature is found, to generate a signal authorizing the user to operate the locking mechanism.

9. A connector system according to claim 8, wherein said scan information includes face recognition, voice recognition, a fingerprint, a code, a pin, a password, or a pattern.

10. A modular robot comprising:
at least one connector for connecting components according to claim 1; and
a plurality of interconnecting modules, where each two adjacently connected modules are connected by the at least one connector, wherein one of the plurality of modules is operable as a core module and all other modules are connected to the core module directly or indirectly through one or more other modules.

11. A modular robot according to claim 10 wherein a first module contains a subset of the electrical connectors of the first cable block and of the second cable block of all modules disposed between the core module and said first module.

12. A modular robot having a plurality of interchangeable modules, the robot comprising:
a first module having an internal sleeve;
a locking mechanism external to the internal sleeve of the first module, and a plunger of the locking mechanism passing through an opening in the sidewall of the internal sleeve;
a second module having an externally extending sleeve dimensioned to fit inside the first sleeve, a sidewall of the externally extending sleeve having an opening aligned with the sidewall of the first sleeve and the plunger of the locking mechanism when the externally extending sleeve is fully inserted into the internal sleeve of the first module; and
a first cable block with electrical connectors in the internal sleeve of the first module and a second cable block with corresponding mating electrical connectors in the externally extending sleeve of the second module,
wherein, when the externally extending sleeve of the second module is fully inserted into the internal sleeve of the first module, the locking mechanism is operable to cause the plunger to move into the sidewall openings of the internal and external sleeves and to hold the sleeves together, and the electrical connectors of the sleeves form an electrical connection through which power and data may flow between the modules.

13. A modular robot according to claim 12 wherein an end of the plunger of the locking mechanism has an inwards slant portion, and wherein as the externally extending sleeve is inserted into the internal sleeve, the externally extending sleeve physically presses against the slant portion of the plunger protruding into the internal sleeve so as to deflect the plunger outward through the opening in the internal sleeve until the externally extending sleeve is fully inserted into the internal sleeve and the plunger is operable to return inward through the second sleeve sidewall opening in the externally extending sleeve.

14. A modular robot according to claim 12, wherein the locking mechanism includes a latching solenoid secured to the first sleeve, and energizing the latching solenoid causes said plunger to move into the second sleeve sidewall opening and hold the internal and externally extending sleeves together.

15. A modular robot according to claim 14 wherein an end of the plunger of the latching solenoid has an inwards slant portion, and wherein as the externally extending sleeve is inserted into the internal sleeve, the externally extending sleeve physically presses against the slant portion of the plunger protruding into the internal sleeve so as to deflect the plunger outward through the opening in the internal sleeve and away from the externally extending sleeve until the externally extending sleeve is fully inserted into the internal sleeve and the plunger is operable to return inward through the second sleeve sidewall opening in the externally extending sleeve.

16. A modular robot according to claim 14, further comprising a communication bus for providing control signals to said solenoid.

17. A modular robot according to claim 16, wherein the communication bus comprises a high speed bus or a low speed bus.

18. A modular robot according to claim 12 further comprising: at least one transponder in the internal sleeve and at least one transponder in the externally extending sleeve, wherein the transponders are operable to communicate with each other.

19. A modular robot according to claim 18, wherein each transponder is operable to provide information to the respective module associated with each transponder.

20. A modular robot according to claim 12 further comprising first and second mounting elements securing the internal sleeve and the external sleeve to respective adjacent modules.

21. A modular robot according to claim 20 wherein the first mounting element includes a flange on the internal sleeve of the first module and the second mounting element includes a base on the externally extending sleeve of the second module.

22. A modular robot according to claim 12 further comprising:
a scanning device operable to scan a feature of a prospective user to generate scan information;
a memory containing scan information of features of authorized users of the connector; and
a control unit operable to compare said scan information from the scanning device with the stored scan information in the memory, and if a matching feature is found, to generate a signal authorizing the user to operate the locking mechanism.

23. A modular robot according to claim 22, wherein said scan includes face recognition, voice recognition, a fingerprint, a code, a pin, a password, or pattern.

24. A modular robot according to claim 12 wherein one of the plurality of interchangeable modules is operable as a core module and all other interchangeable modules are connected to the core module directly or indirectly through one or more interchangeable modules.

25. A modular robot according to claim 24 wherein a first interchangeable module contains a subset of the electrical connectors of the first cable block and of the second cable block of all the interchangeable modules disposed between the core module and the first interchangeable module.

26. A modular robot according to claim 25 wherein interchangeable modules more distant from the core module contain fewer electrical connectors than interchangeable modules less distant from the core module.

27. A modular robot according to claim 14, wherein the locking mechanism includes a fail safe, a fail secure, or a memory locking mechanism.

28. A connector system comprising:
a first connector operable to connect a first module to a second module;
a second connector operable to connect the second module to a third module;
wherein the second connector includes connection functionality for the third module, and the first connector includes connection functionality for both the second and third modules.

29. A connector for components comprising:
a first component having a first cable block with electrical connectors and a second component having a second cable block with corresponding mating electrical connectors;
a locking mechanism operable to mechanically mate the first component and the second component; and
wherein, the locking mechanism is operable to connect the electrical connectors of the first cable block with the electrical connectors of the second cable block to allow power and data to flow between the first and second components.
